(19) United States
(12) Patent Application Publication
(10) Pub. No.: US 2009/0126545 A1
(43) Pub. Date: May 21, 2009

(54) Automated trim press and shuttle system

(75) Inventor: James S. Luebke, Kaukana, WI (US)

Correspondence Address: RYAN KROMHOLZ & MANION, S.C., POST OFFICE BOX 26618, MILWAUKEE, WI, 53226, US

(73) Assignee: Advanced Foundry Specialist, LLC

(21) Appl. No.: 12/313,106

(22) Filed: Nov. 17, 2008

Related U.S. Application Data
(60) Provisional application No. 61/003,245, filed on Nov. 15, 2007.
(60) Provisional application No. 61/126,141, filed on May 1, 2008.

(51) Int. Cl. B26D 5/20; B26D 7/06

(52) U.S. Cl. 83/72; 83/23; 83/53; 100/39; 83/640

(57) ABSTRACT

A press system having an integrated frame and press box for a foundry apparatus such as a trim press. The frame includes a top member, a bottom member and a pair of spaced apart side columns located between the top and bottom member. The press box is slidably coupled to the frame. The press system includes guideway bearings, and an integrated hydraulic box to form a system which minimizes deflection. The press system includes a controller having a program which operates the press system. The press system includes detection devices to provide input to the controller and a human-machine interface to provide input to the controller and to display output from the controller.

### RELATED APPLICATIONS

This application claims the benefit of U.S. Provisional Patent Application Ser. No. 61/003,245, filed 15 Nov. 2007 and entitled “Integrated H-Frame and Press Box” and U.S. Provisional Patent Application Ser. No. 61/126,141, filed 1 May 2008, and entitled “Automated Trim Press and Shuttle System.”

### BACKGROUND OF THE INVENTION

Many machines include parts cast of metal. The casting process involves melting metal and forming the molten metal into a particular shape using a form or mold. Often, a freshly cast part will often have various imperfections. For example, there may be excess material where the parts of the form come together or where the metal is inserted into the form. These imperfections may be removed by hand using a grinder or automatically using a trim press. A trim press is a device adapted to trim and deburr a cast piece.

### SUMMARY OF THE INVENTION

The present invention provides systems, methods and apparatus for an integrated trim press.

A system of the present invention includes a frame, a press box, a first detection device, and at least one controller. The press box may be slidably coupled to the frame and operably connected to the controller. The first detection device may be operably connected to the controller and adapted to provide input to the controller about the position of the press box relative to the frame. The controller may be operably connected to the press box and the first detection device.

The system may include at least one power source operably connected to the controller.

The system may include at least one operator input device operably connected to the controller and adapted to provide input to the controller.

The system may include at least one output display device operably connected to the controller and adapted to display output from the controller.

The system may include a frame having a first side member with a first end and a second end and a second side member with a first end and a second end. The system may also include a top member with a first end coupled to the first end of the first side member and a second end coupled to the first end of the second side member. The system may also include and a bottom member with a first end coupled to the second end of the first side member and a second end coupled to the second end of the second side member.

The system may include a press box having a box frame, the box frame having a first side member, a second side member, a front member, and a rear member, a top plate coupled to a top surface of the box frame, and a retaining plate coupled to a bottom surface of the box frame.

The system may include a first track coupled to an inside surface of the first frame side member and a second track coupled to an inside surface of the second frame side member. The system may also include a first sliding element coupled to the first box frame side member, the first sliding element being sized and configured for mating engagement with the first track. The system may also include a second sliding element coupled to the second box frame side member, the second sliding element being sized and configured for mating engagement with the second track.

The system may include a press box wherein the press box includes a knockout plate disposed within the press box and the knockout plate is operably connected to a controller.

The system may include a second detection device operably connected to the controller and adapted to provide input to the controller about the position of the knockout plate relative to the press box.

The system may include a first detection device and/or second detection that is a linear transducer.

The system may include a shuttle assembly coupled to the frame.

The system may include a shuttle assembly having a shuttle frame, a shuttle table, and a motion device. The shuttle table may be slidably coupled to the transfer shuttle frame. The shuttle table may have a first segment coupled to an adjacent second segment. The motion device may be coupled to the frame and the shuttle table. The motion device may be operably connected to the controller.

The system may include a shuttle table wherein the first segment is coupled to the second segment through a linking element.

The system may include a linking element having a first edge and an opposed second edge. The system may include a first shuttle table segment having a first engaging edge. The system may include a second shuttle table segment has a second engaging edge, the second engaging edge being adjacent the first engaging edge. The linking element first edge may be sized and configured for interlocking engagement with the first shuttle table segment engaging edge and the linking element second edge may be sized and configured for interlocking engagement with the second shuttle table segment engaging edge.

The system may include a locking mechanism, the locking mechanism having an engaging device and an anvil device. The anvil device may have a passage therein, the passage being sized and configured for slidably mating with the engaging device. The engaging device may be sized and configured to engage a lock element coupled to a bottom surface of the shuttle table.

The system may include an engaging device which is operably connected to the controller. The system may include a controller adapted to operate the engaging device.

The system may include a motion device coupled to the shuttle assembly and operably connected to the controller.

A method of the present invention includes providing a press system, providing a tool, the tool being coupled to a bottom surface of the press box, providing a part, loading a part onto the shuttle assembly, trimming a part and removing a part from the press system. The press system may include a frame and a press box. The press box may be slidably coupled to the frame and movable between a first position and a second position. The press system may also include a shuttle assembly coupled to the frame. The shuttle assembly may include a shuttle frame and a shuttle table slidably coupled to the shuttle frame. The shuttle table may have a first table segment and a second table segment. The shuttle table may be slidable between a first position and a second position wherein in the first position the second table segment is located under the press box and in the second position the first table segment is located under the press box.

The method may include moving the shuttle table to its first position and placing a part on the first table segment.

The trimming step of the method may include moving the shuttle table from the first position to the second position, lowering the press box to trim a part and raising the press box, the part being held in place by the tool.

The removing step of the method may include moving the shuttle table from the second position to the first position, ejecting the part from the tool onto the second table segment and unloading the part from the second table segment.

The press assembly of the method may include a press box motion device coupled to the press box, a shuttle table motion device coupled to the shuttle, at least one detection device coupled to the press frame and a controller operably connected to the press box motion device, the shuttle table motion device, and the at least one detection device.

The method may include a controller adapted to operate the press box motion device to move the press box between its first position and its second position. The method may include a controller adapted to operate the shuttle table motion device to move the shuttle table between its first position and its second position.

### BRIEF DESCRIPTION OF THE DRAWINGS

FIG. 1 is a perspective view of an embodiment of a press system according to the present invention with the press box in the open position.

FIG. 2 is a front perspective of the press box of the press system of FIG. 1.

FIG. 3 is a rear plan view of the press box of the press system of FIG. 1.

FIGS. 4A and 4B are a front plan view and a rear plan view of the trim press the press box in the engaged position.

FIG. 5 is a perspective view of an alternative embodiment of a trim press according of FIG. 1 including a transfer shuttle assembly.

FIGS. 6A and 6B are perspective views of the transfer shuttle assembly of FIG. 5 in a first load position and second trim position.

FIG. 7 is a perspective view of the transfer shuttle of FIG. 5.

FIG. 8 is a perspective view of the transfer shuttle of FIG. 7 with parts removed to view the internal mechanisms.

FIG. 9 a partial perspective view of the transfer shuttle assembly of FIG. 7.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

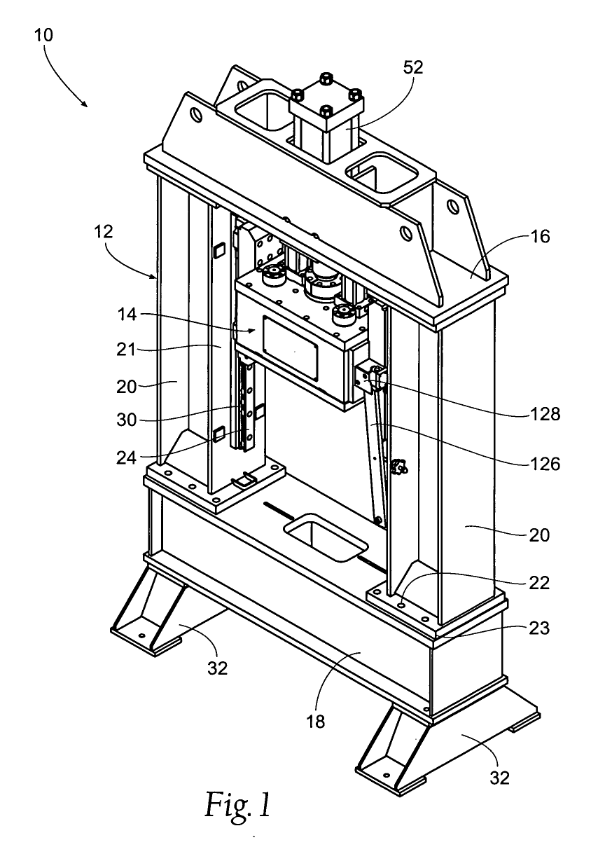

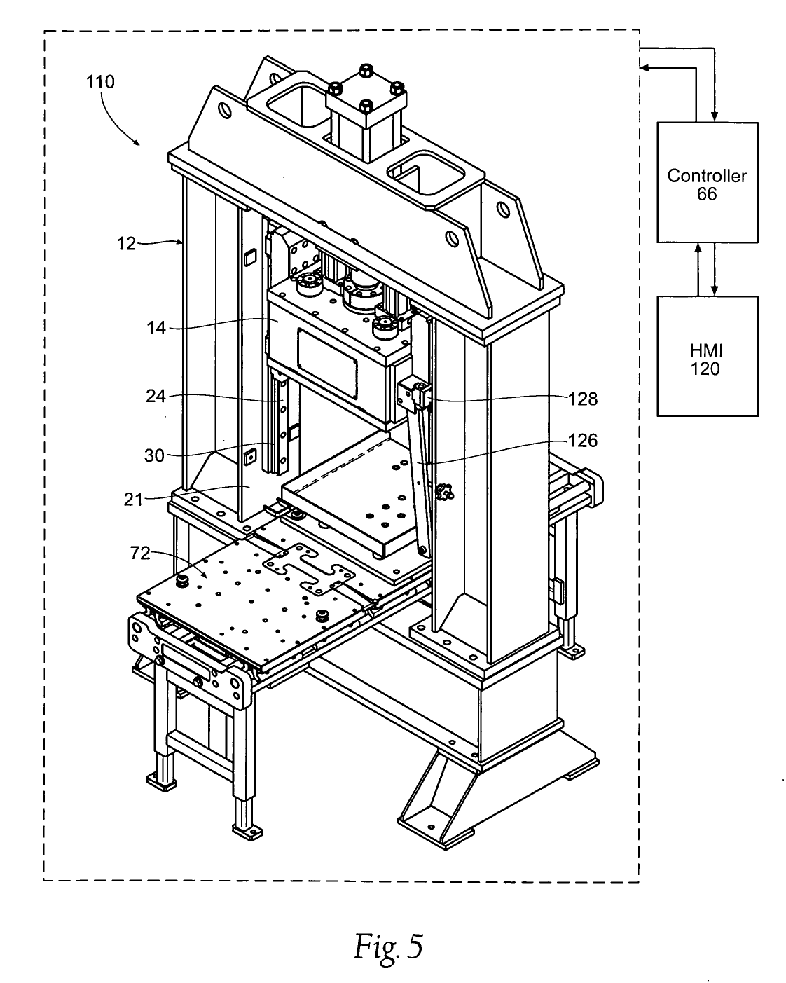

A preferred embodiment of a trim press system 10 is shown in FIGS. 1 to 4B. The illustrated embodiment of the trim press system 10 includes a frame 12 and a press box 14. If desired, the trim press system 10 may include a transfer shuttle 64 as shown in FIG. 5.

As shown in FIG. 1, the frame preferably includes a top member 16, a bottom member 18, and a pair of spaced apart side columns 20 disposed between the top 16 and bottom 18 members. Each side column 20 may be coupled to the top member 16 and bottom member 18 using any means known in the art including, but not limited to, bolts 22. For example, as shown in FIG. 1 a flange 23 is formed at each end of each side column 20. The side columns 20 maybe coupled to the top member 16 and bottom member 18 by fastening at least one bolt 22 through these flanges 23.

As shown in FIG. 1, it is also contemplated that it may be desirable, though not necessary, that a pair of feet 32 to the bottom member 18 of the frame 12. The feet 32 may be coupled to the frame 12 using any means known in the art including, but not limited to bolts.

A track 24 is preferably attached to the inside surface 21 of each side column 20 as shown in FIG. 1. A press box 14, as will be described in more detail below, is located between the side columns 20. The press box 14 preferably includes a side plate 26 coupled to either side of the press box 14. The side plates 26 are adapted to slidably engage the tracks 24 coupled to the side columns 20. The side plates 26 may be slidably engaged with the tracks 24 through any type of sliding device 28, including, but not limited to bearings.

It is contemplated that the track 24 may have an indentation 30 formed on either side thereof. It is further contemplated that the sliding devices 28 may be formed to mate with the indentations 30, thus holding the press box 14 in place in the lateral direction while still allowing the press box 14 to slide along the tracks 24.

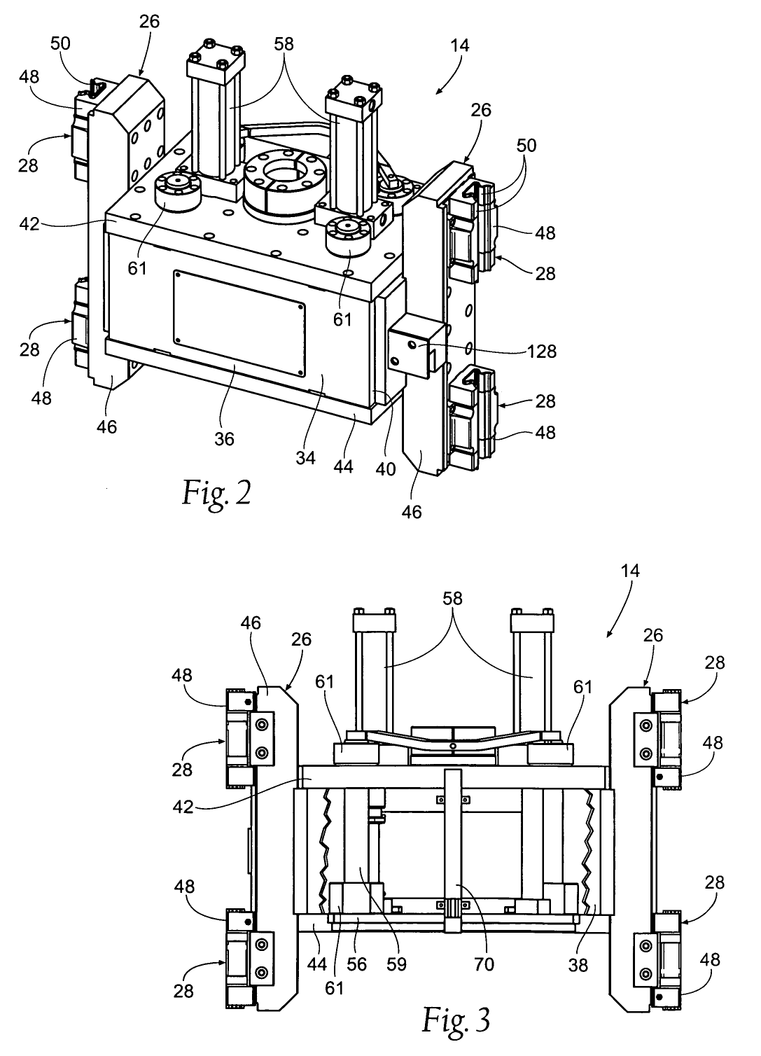

FIGS. 2 and 3 show an illustrated embodiment of a press box 14. The press box 14 preferably includes a box frame 34 comprising a front member 36, an opposed back member 38, and a pair of opposed side members 40. The box frame 14 is preferably welded together. The box frame 14 preferably has an upper plate 42 coupled to a top side of the box frame 14 and a lower retaining plate 44 coupled to the bottom side of the box frame 14.

In the illustrated embodiment the side plates take the form of bearing mounts 46 which are coupled to each of the side members 40. The sliding devices 26 take the form of at least one bearing 48. Preferably, at least one bearing 48 is disposed in each of the bearing mounts 46. In the illustrated embodiment two bearings 48 are provided in each bearing mount 46. As seen in FIG. 2, the bearings 48 preferably include a pair of projections 50 which are adapted to engage the indentations 30 on either side of the track 24.

In this manner the press box 14 is integrated to the frame 12 with linear sliding guide ways which minimizes deflection and provides extremely rigid mounting and alignment of trim tooling. It is contemplated that the press box 14 may be moved along the tracks 24 using any means known in the art including, but not limited to hydraulic means or pneumatic means. In the illustrated embodiment the press box 14 is activated by a hydraulic ram 52. The main ram 52 is preferably coupled to the frame 12 and to the press box 14.

The press box 14 is integrated to the press device 10 by tying all moving parts to the columns 20 of the press frame 12. The enclosed rectangular construction of the box 14 minimizes diagonal deflection. Each side column 20 of the frame 12 is tied to both the top member 16 and the bottom member 18, in effect tying all of the members 16, 18, 20 of the frame 12 together.

It is contemplated that in use, a tool 54 or a die may be attached to the press box 14. The cast part to be trimmed may be placed underneath the press-box 14 (not shown). It is contemplated that the cast part may be places on a nest (not shown) located on the load/trim portion of the shuttle table. As stated above, the press box 14 is not allowed to move laterally, rather the press box 14 is only allowed to slide up and down along the tracks 24, aiding in the alignment of the tool 54 with the part.

A knockout plate 56 is located within the press box 14. The knockout plate 56 is retained within the press box 14 by the lower retaining plate 44. The knockout plate 56 is preferably moved up and down within the press box 14 by way of at least one hydraulic cylinder 58. In this illustrated embodiment the knockout plate 56 is actuated by two hydraulic cylinders 58. The knockout plate 56 is preferably guided by a plurality of knockout guide rods 60 which are supported by knockout guide supports 62. Each guide rods 60 is retained within the press box 14 by a retainer 61.

As will be described in more detail below, detection devices 64 are built into the system 10 to determine whether a part is present and whether a part is nested within the tool 54 and is adaptable to different sized parts and trim pressures. In the illustrated embodiment the detection devices 64 are preferably in electronic communication with a controller 66. The system 10 is controlled by the controller 66 based on input from the detection device 64. In the illustrated embodiment the detection devices 64 take the form of at least one linear transducer. In this manner expensive detection devices are built into the press system 10 rather than each individual tool.

A press position linear transducer 68 is coupled to the press frame 12. The press position linear transducer 68 is adapted to sense the position of the press box 14. The press system 10 preferably includes at least one knockout plate linear transducer 70 coupled to the press box 14. The knockout plate linear transducer 70 is adapted to sense the position of the knockout plate 54. As stated above, each of the linear transducers 68, 70 is preferably in electronic communication with the controller 66 and provides information to the controller 66. The feedback from the linear transducers 68, 70 is utilized to run the system program.

As shown in FIG. 5, the press system 10 may include a shuttle assembly 72. The shuttle assembly 72 preferably includes a shuttle frame 74 and a shuttle table 76. The shuttle frame 74 generally comprises a pair of end members 90 with a pair of longitudinal frame members 84 extending between the end members 90. The frame further includes a pair of longitudinally extending guide rails 86 extending between the end members 90.

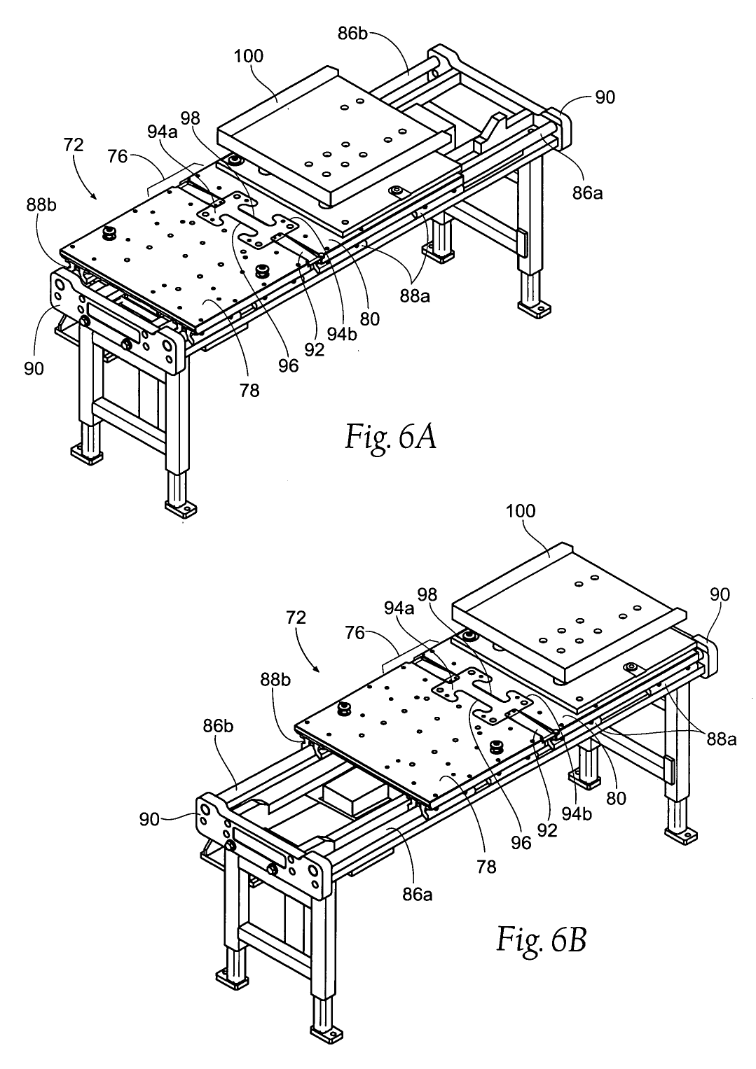

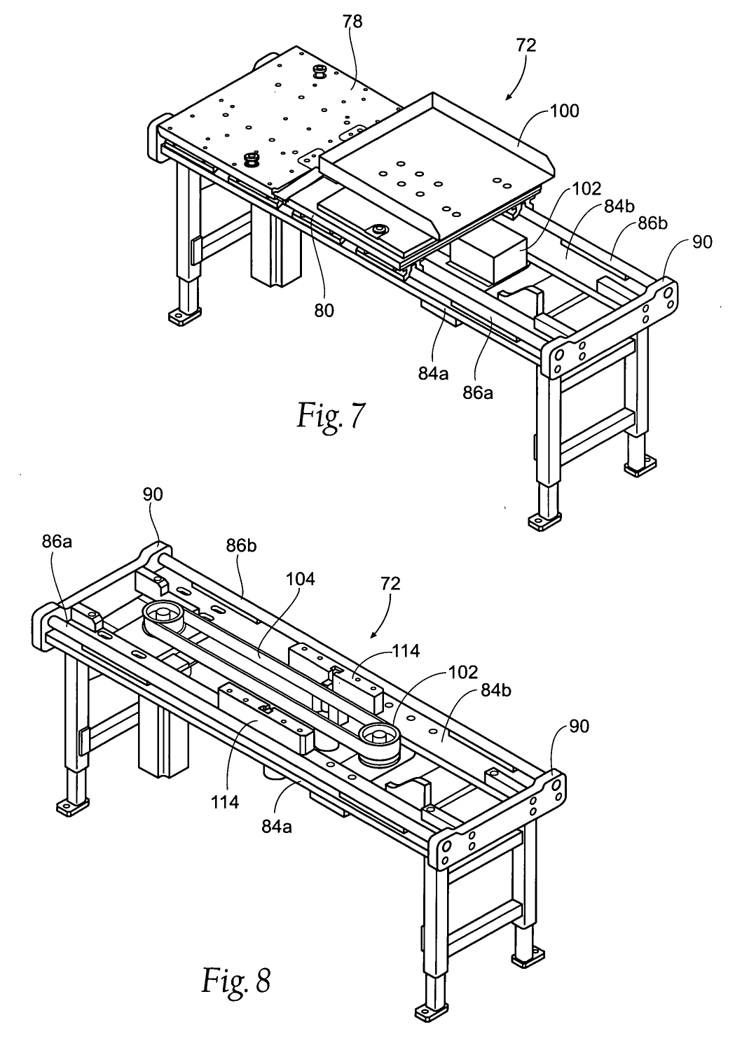

The shuttle table 76 preferably includes a first load/trim segment 78 coupled to a second unload segment 80 by a transfer table link 82. As shown in FIG. 6A, the transfer table link 82 preferably includes a first interlocking edge 94a and a second interlocking edge 94b. The load/trim segment 78 preferably has an interlocking edge 96 which is sized and configured to cooperate with the transfer link first interlocking edge 94a. The unload segment 80 preferably has an interlocking edge 98 which is sized and configured to cooperate with the transfer link second interlocking edge 94b. The shuttle table 76 may further include a shuttle table guard 92 disposed between the load/trim segment 78 and the unload segment 80 of the shuttle table 76.

The shuttle table 76 is preferably movable between a first position (FIG. 6A) and a second position (FIG. 6B). Each segment 78, 80 of the shuttle table 76 preferable includes a pair of sliding elements 88 coupled the bottom side thereof. The sliding elements 88 are preferably sized and configured to slidably engage a pair of longitudinal rails 86. The sliding elements are arranged generally at the lateral sides of each segment 78, 80 of the shuttle table 76 such that a first sliding element 88a engages a first longitudinal rail 86a and a second sliding element 88b engages a second longitudinal rail 86b. In the illustrated embodiment, two sliding elements 88 are provided on each lateral side of each segment 78, 80 of the shuttle table 76.

The illustrated embodiment of FIGS. 5 to 6B includes a dump tray 100 coupled to the unload segment 80 of the shuttle table 76. In such a configuration, a part will be deposited into the dump tray 100 after the trim process is complete, as will be described in more detail below. However, it is contemplated that, if desired, the dump tray 100 may be eliminated and the part may be deposited directly onto the unload segment 80 of the shuttle table 76 after the trim process is complete.

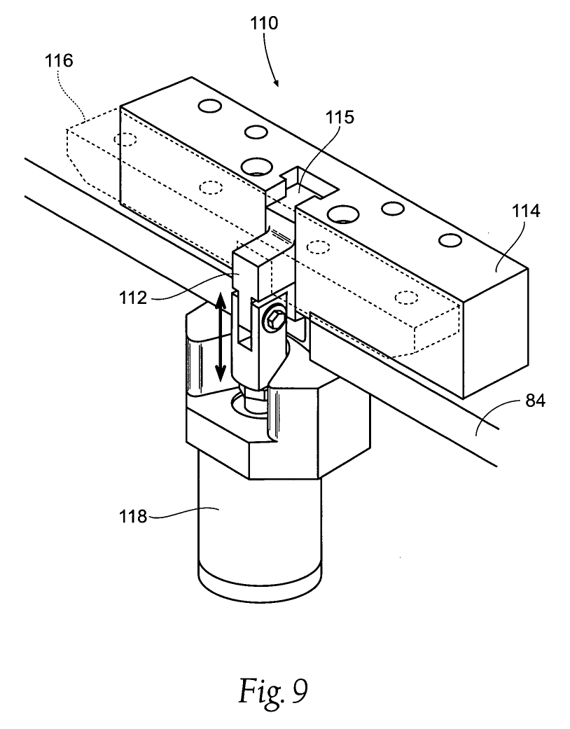

The shuttle assembly 72 is preferably integrated to the press frame 12. The shuttle assembly 72 is preferably attached to the frame 12 by at least one fixation member. The fixation member may take any form known in the art, including, but not limited to bolts. As shown in FIGS. 8 and 9, the motion of the shuttle table 76 is preferably provided by a servo driven gear box 102 and cogged belt drive 104 attached to the shuttle table 76. This drive system reduces planned maintenance caused by environmental contaminants including trimmings from castings, sand and dirt.

The shuttle table 76 preferably locks into position to minimize unwanted motion caused by the trimming process. FIG. 9 shows an illustrated embodiment of a shuttle table locking mechanism 110. The locking mechanism 110 preferably includes two keys 112, each key 112 guided by a mating hole 115 formed in an anvil block 114. In the illustrated embodiment the first anvil block 114a and the second anvil block 114b are preferably disposed in generally the same longitudinal position along the length of the shuttle frame 12 with the first anvil block 114a coupled to the first longitudinal frame member 84a and the second anvil block 114b coupled to a second longitudinal frame member 84b. Each key 112 is preferably associated with an air cylinder 118, the air cylinder 118 being adapted to activate the key 112 and lock the gib block 118 relative to the anvil block 114. The gib blocks, 118 are preferably coupled to the underside of the shuttle table 76. The anvil blocks 114 are also used as a support for the shuttle table 76 to prevent side loading and to take the full pressure of the press, thus allowing the linear guide rails 86 to flex. In the illustrated embodiment, the shuttle table 76 slides into position over the anvil blocks 114 and deflects down-on to anvil blocks 114 to firmly position the shuttle table 76 and the casting carried thereon for the trim process. The locking mechanism 110 is designed to counter any direct and side loads that the shuttle table 76 might be subjected to during normal use.

A tool 54 is preferably coupled to the press box 14. Tool design and trade secrets are developed specifically to work with the press, hydraulic box and shuttle. A unique tool 54 is utilized for each part to be trimmed. The tool 54 may include an internal holding device (not shown) to secure the casting while the part is being trimmed and while the part is being transferred.

The press system 10 preferably includes a controller 66 and a human-machine interface (HMI) 120. The controller 66 may take any form known in the art and may preferably be a programmable logic controller. Preferably, a power source (not shown) is coupled to the press system 10 to provide power to the system 10. The controller 66 and the HMI 120 may be integrally formed, or the controller 66 may be separate from the HMI 120 and in either wired or wireless communication with the HMI 120. Preferably the system 10 includes a single HMI 120 for entry of user input and display of machine output. However, it is contemplated that separate HMIs 120 could be utilized for entry of user input and display of machine output.

The press system 10 preferably includes at least one program designed to integrate the system functions. The program preferably controls the movement of the press box 14. The program may also control the movement of the transfer shuttle 72. The program preferably controls the movement of the components of the system 10 based on input from the at least one detection device 64, which in the preferred embodiment comprise linear transducers 68, 70. Each tool 54 used by the system 10 preferably has a unique program.

As previously discussed, the at least one detection device 64 aids the system 10 in determining if a part is present, if a part is jammed, and if a part is not properly nested.

In use, as the main ram 52 is extended the press position linear transducer 68 reads the position of the press box 14 in relation to the bottom member 18 of the press frame 12. As main ram 52 is lowered, the controller 66 looks for movement of the knockout box linear transducer 70. The program has a stored value for when the knockout plate 56 should come in contact with the part. It should be understood that as each tool 54 has a unique program, this value may be unique for each tool 54. The program compares the movement information received from the knockout plate linear transducer 70 with the stored value. If the knockout plate linear transducer 70 moves before it should have, the controller 66 stops the movement of the ram 52 and press box 14 and displays an alarm indicating that the part is not nested.

If the knockout plate linear transducer 70 moves before it should have, the controller 66 stops the movement of the ram 52 and press box 14 and displays an alarm indicating that the part is not present.

When the main ram 52 is being extended the program is constantly comparing the position of the knockout linear transducer 70 to the preset contact position. Until the knockout linear transducer 70 reaches its contact position the main ram 52 is operating at only 10% of its total tonnage. If contact between the knockout plate 56 and the part is reached at the correct predetermined position, the tonnage is increased to the preset trim value to trim the part. In this manner, the system 10 prevents destroying a tool 54 and is able to operate in a safer manner.

After the ram 52 is fully extended and the part is trimmed, the ram 52 begins to retract. The program compares the position of the knockout box linear transducer 70 to the press position linear transducer 68. If the knockout box linear transducer 70 does not immediately start going in the opposite direction and read proportionally with the press position linear transducer 68 the controller stops the movement of the ram 52 and press box 14 and displays an alarm indicating that the part is jammed.

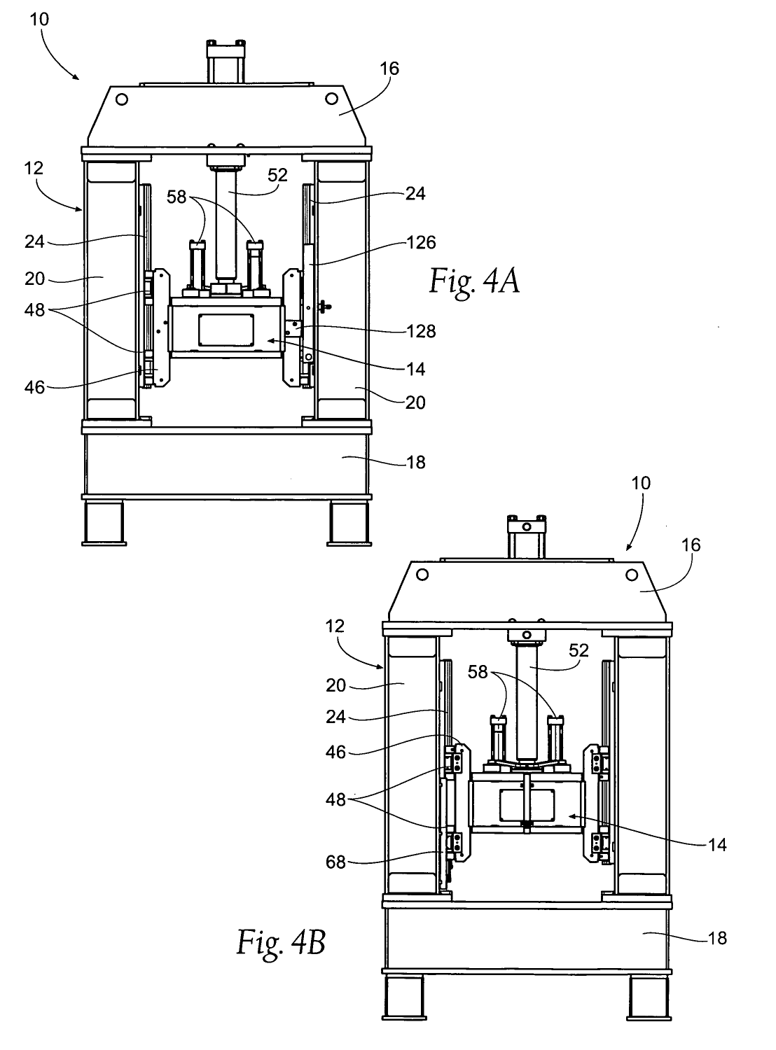

The program is preferably adapted to control both the press box 14 and the shuttle table 76. The press box 14 has a first open position (FIG. 1) and a second engaged position (FIG. 4A). As discussed above, the shuttle table 76 has two positions. In the first position the system 10 is configured to allow for loading a part onto the shuttle table 76 and is adapted to eject a part from the tool 54 onto the shuttle table 76. These actions can occur simultaneously if desired. In the second position, the system 10 is adapted to trimming a part and removing a part from the shuttle table 76. These actions can occur simultaneously if desired.

In use, the load/trim segment 78 of the shuttle table 76 is positioned at the operator's position. A part is placed on a lower tooling nest 122 located on the load/trim segment 78 of the shuttle table 76. The shuttle table 76 then moves the load/trim segment 78 to the trim position directly under the press box 14. The press box 14 is then extended, trimming the part, and retracted, carrying the part in the upper tooling 54, to the press box open position. The shuttle table 76 then returns to its original position such that the load/trim segment 78 is at the operator position and the unload segment 80 of the shuttle table 76 is positioned under the press box 14. While the operator is loading the next part on to the lower tooling nest 122 on the trim/load segment 78 of the shuttle table 76, the press box 14 is extended, ejecting the trimmed part from the upper tooling 54, on the unload segment 80 of the shuttle table 76. The shuttle assembly 72 again moves the load/trim segment 78 of the shuttle table 76 to the trim position under the press box 14 which moves the unload segment 80 of the shuttle table 76 to the unload position at the back of the press system 10. The trimmed part is then removed from the shuttle table 76 while the next part is being trimmed.

The illustrated embodiment includes a dump tray 100 coupled to the unload segment 80 of the shuttle table 76. In use, when the shuttle table 76 reaches its second position the dump tray 100 tips, allowing the part to slide into a receptacle, such as a finished parts bin, while the next part is being trimmed. It is also contemplated that the unload segment 80 of the shuttle table 76 could be provided without a dump tray. In such an embodiment the press box 14 could eject the trimmed part onto the unload segment 80 of the shuttle table 76. In such an embodiment the unload segment 80 of the shuttle table 76 could further include a nest to support the ejected part. The shuttle assembly 72 would then move the load/trim segment 78 of the shuttle table 76 to the trim position under the press box 14, whereby the unload segment 80 of the shuttle table 76 will be at the unload position at the back of the press assembly 10. A robot or pick-n-place may then remove the part from the unload segment 80 of the shuttle table 76 while the next part is being trimmed.

It is contemplated that either a robot or an operator may load the parts onto the lower tooling nest 122 prior to trimming the part.

It is contemplated that the integrated frame 12 and press box 14 could be utilized in any type of foundry equipment including, but not limited to a trim press, a die cast machine, or any other type of cutting, punching, or press machine.

It is contemplated that the press system 10 may include a press box 14 locking mechanism. The illustrated embodiment includes a rotatable bar 126 coupled to the inside surface 21 of one of the side columns 20 of the frame 12. A locking block 128 is coupled to the press box 14 such that when the press system 10 is in its open position the locking block 128 is adjacent the free end of the rotatable bar 126. In this manner, the free end of the rotatable bar may be slid into the locking block 128 as shown in FIG. 1. In this manner, the press box 14 is held in its open position and any necessary maintenance or tooling set up may be performed on the press system 10. When the press is in operation, the rotatable bar 128 is rotated out of the way of the press box 14 such that it is generally parallel with the side columns 20 as shown in FIG. 4A.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

1. A press system comprising:
a frame;
a press box slidably coupled to the frame, the press box being operably connected to a controller;
a first detection device operably connected to the controller and adapted to provide input to the controller about the position of the press box relative to the frame; and
at least one controller operably connected to the press box and the first detection device.

2. The system of claim 1 further comprising at least one power source operably connected to the controller

3. The system of claim 1 further comprising at least one operator input device operably connected to the controller and adapted to provide input to the controller.

4. The system of claim 1 further comprising at least one output display device operably connected to the controller and adapted to display output from the controller.

5. The system of claim 1 wherein said frame further comprises:
a first side member having a first end and a second end;
a second side member having a first end and a second end;
a top member having a first end and a second end, the first end being coupled to the first end of the first side member and the second end being coupled to the first end of the second side member; and
a bottom member having a first end and a second end, the first end coupled to the second end of the first side member and the second end being coupled to the second end of the second side member.

6. The press system of claim 5 wherein the press box further comprises:
a box frame, the box frame having a first side member, a second side member, a front member, and a rear member;
a top plate coupled to a top surface of the box frame, and
a retaining plate coupled to a bottom surface of the box frame.

7. The system of claim 6 further comprising
a first track coupled to an inside surface of the first frame side member;
a second track coupled to an inside surface of the second frame side member;
a first sliding element coupled to the first box frame side member, the first sliding element being sized and configured for mating engagement with the first track; and
a second sliding element coupled to the second box frame side member, the second sliding element being sized and configured for mating engagement with the second track.

8. The system of claim 6 wherein the press box includes a knockout plate disposed within the press box, the knockout plate being operably connected to a controller.

9. The system of claim 8 further comprising a second detection device operably connected to the controller and adapted to provide input to the controller about the position of the knockout plate relative to the press box.

10. The system of claim 9 wherein at least one of the first detection device and the second detection device further comprise a linear transducer.

11. The system of claim 1 further comprising a shuttle assembly coupled to the frame.

12. The system of claim 11 wherein the shuttle further comprises:
a shuttle frame;
a shuttle table slidably coupled to the transfer shuttle frame, the shuttle table having a first segment coupled to an adjacent second segment; and
a motion device coupled to the frame and the shuttle table, the motion device operably connected to the controller.

13. The system of claim 12 wherein the first segment is coupled to the second segment through a linking element.

14. The system of claim 13 further where
the linking element has a first edge and an opposed second edge;
the first shuttle table segment has a engaging edge;
the second shuttle table segment has a engaging edge, the second shuttle table engaging edge being adjacent the first shuttle table engaging edge; and
wherein the linking element first edge is sized and configured for interlocking engagement with the first shuttle table segment engaging edge and the linking element second edge is sized and configured for interlocking engagement with the second shuttle table segment engaging edge.

15. The system of claim 12 further comprising
a locking mechanism, the locking mechanism having an engaging device and an anvil device, the anvil device having a passage therein, the passage being sized and configured for slidably mating with the engaging device, wherein the engaging device is sized and configured to engage a lock element coupled to a bottom surface of the shuttle table.

16. The system of claim 15 wherein the engaging device is operably connected to the controller and the controller is adapted to operate the engaging device.

17. The system of claim 12 further comprising
a motion device coupled to the shuttle assembly and operably connected to the controller.

18. A method comprising
providing a press system, the press system including:
a frame;
a press box slidably coupled to the frame, the press box being slidable between a first position and a second position;
a shuttle assembly coupled to the frame, the shuttle assembly having a shuttle frame and a shuttle table slidably coupled to the shuttle frame, the shuttle table having a first table segment and a second table segment, the shuttle table being slidable between a first position and a second position wherein in the first position the second table segment is located under the press box and in the second position the first table segment is located under the press box;
providing a tool, the tool being coupled to a bottom surface of the press box;
providing a part;
loading a part onto the shuttle assembly;
trimming a part; and
removing a part from the press system.

19. The system of claim 18 wherein the loading step further comprises:
moving the shuttle table to its first position; and
placing a part on the first table segment.

20. The system of claim 19 wherein the trimming step further comprises:
moving the shuttle table from the first position to the second position;
lowering the press box to trim a part; and
raising the press box, the part being held in place by the tool.

21. The method of claim 20 wherein the removing step further comprises:
moving the shuttle table from the second position to the first position;
ejecting the part from the tool onto the second table segment; and
unloading the part from the second table segment.

22. The method of claim 21 wherein the press assembly further includes
a press box motion device coupled to the press box;
a shuttle table motion device coupled to the shuttle;
at least one detection device coupled to the press frame; and
a controller operably connected to the press box motion device, the shuttle table motion device, and the at least one detection device.

23. The method of claim 22 wherein
said controller is adapted to operate the press box motion device to move the press box between its first position and its second position; and
said controller is adapted to operate the shuttle table motion device to move the shuttle table between its first position and its second position.
